(19) United States
(12) Patent Application Publication
(10) Pub. No.: US 2016/0295541 A1
(43) Pub. Date: Oct. 6, 2016

(54) CELL ACQUISITION SYSTEMS AND PROCESSES FOR MULTI-SIM DEVICES

(71) Applicant: QUALCOMM Incorporated, San Diego, CA (US)

(72) Inventors: Bipin Kumar Jaiswal, Hyderabad (IN); Vishnu Namboodiri Karakkad Kesavan Namboodiri, Kannur, Kerala (IN); Nilotpal Dhar, Hyderabad, Andhra Pradesh (IN)

(21) Appl. No.: 14/678,754

(22) Filed: Apr. 3, 2015

(51) Int. Cl. H04W 60/00; H04W 56/00; H04W 48/16; H04W 8/18

(52) U.S. Cl. CPC H04W 60/00; H04W 8/183; H04W 56/001; H04W 48/16; H04W 84/042

(57) ABSTRACT

Systems and methods are described herein for managing acquisitions including, but not limited to, executing a first portion of a first acquisition process for acquiring service for a first subscription of a user equipment (UE); obtaining at least one parameter as a result of executing the first portion of the first acquisition process; and executing a second portion of a second acquisition process for acquiring service for a second subscription of the UE using the at least one parameter.

### BACKGROUND

1. Field

Embodiments described herein generally relate to radio access technologies (RATs), and more specifically, to acquisition processes in a multi-subscription user equipment (UE).

2. Background

A UE, such as a mobile phone device, may include a plurality of subscriber identity modules (SIMs). For example, when all SIMs in a multi-SIM UE are active, the UE may be a multi-SIM-multi-active (MSMA) UE. When one SIM in a multi-SIM UE is active while the rest of the SIM(s) is standing by, the UE may be a multi-SIM-multi-standby (MSMS) UE. Each SIM may be provided a subscription to a RAT, such as, but not limited to, Frequency Division Multiple Access (FDMA), Time Division Multiple Access (TDMA), Code Division Multiple Access (CDMA), Universal Mobile Telecommunications Systems (UMTS) (particularly, Wideband Code Division Multiple Access (WCDMA), Long Term Evolution (LTE), and the like), Global System for Mobile Communications (GSM), General Packet Radio Service (GPRS), Wi-Fi, Personal Communications Service (PCS), or other protocols that may be used in a wireless communications network or a data communications network. Cell acquisition processes may include serving cell searching and linking The cell acquisition processes may take a considerably long time. For example, WCDMA acquisition may take at least 250 ms.

While two or more subscriptions of a same UE will eventually find a same serving cell (e.g., provided by a base station), undergoing the entire acquisition process (including searching for the same serving cell) may be inefficient in terms of power and time. This is because the serving cell may only need to be found once given the serving cell is the same for the two or more subscriptions of a multi-SIM UE. In particular, when radio frequency (RF) resources are shared between the two or more subscriptions, the time for the UE to acquire a second subscription may be affected by RF resources usage of a first subscription. In addition, even when RF resources are not shared (e.g., each subscription may have its own set of RF resources), the second subscription may be affected by RF resources usage of the first subscription due to de-sensing.

### SUMMARY

Embodiments described herein relate to efficient cell acquisition for two or more subscriptions provided to a user equipment (UE). Each of the two or more subscriptions may be enabled by a subscriber identity module (SIM) provided to the UE, as in the context of a multi-SIM UE. In cell acquisition processes, two or more subscriptions of the multi-SIM UE may eventually locate the same serving cell during the cell searching stages of the acquisition processes. This may occur when the two or more subscriptions belong to a same public land mobile network (PLMN). Systems and methods are described herein relating to a first acquisition process (for a first subscription) and a second acquisition process (for a second subscription. In particular, information obtained during the first acquisition process relating to the serving cell may be used in the second acquisition process, where the same serving cell may be linked to the UE by both the first acquisition process and the second acquisition process.

For example, at least one parameter, obtained in the first acquisition process may be used in a second acquisition process. The at least one parameter may be a primary scrambling code (PSC) determined at a PSC identification phase of the first acquisition process. The at least one parameter may additional include a determined frequency, frame timing, and system information obtained at various phases of the first acquisition process. Such parameters may then be used in frequency pull-in of the second acquisition process (as well as the first acquisition process). When the first subscription and the second subscription are determined to be associated with a same PLMN, the second acquisition process may be initiated at a PN searching phase of the frequency pull-in stage of the second acquisition process. The second acquisition process may include the frequency pull-in and decoding primary common control physical channel (PCCPCH), foregoing frequency scanning and PSC determination.

In various embodiments, a method is described for managing acquisitions, including, executing a first portion of a first acquisition process for acquiring service for a first subscription of a UE. At least one parameter is obtained as a result of executing the first portion of the first acquisition process. A second portion of a second acquisition process is executed for acquiring service for a second subscription of the UE using the at least one parameter.

In further embodiments, the UE is provided with the first subscription and the second subscription.

According to some embodiments, the first subscription and the second subscription are associated with a same radio access technology (RAT).

In some embodiments, the first subscription and the second subscription are associated with a same PLMN.

In some embodiments, executing the second portion of the second acquisition process includes determining a PLMN associated with each of the first subscription and the second subscription and executing the second portion of the second acquisition process based on the at least one parameter when the PLMN associated with the first subscription and the PLMN associated with the second subscription are the same.

In various embodiments, the at least one parameter is at least one of frequency, PSC, frame timing, or system information.

In some embodiments, the second portion of the second acquisition process includes at least a frequency pull-in stage. One of the at least one parameter is used in the frequency pull-in stage.

In some embodiments, the frequency pull-in stage includes at least a multipath searching phase and a pulling-in phase. One of the at least one parameter is used in the multipath searching phase.

In further embodiments, the second acquisition process includes only the second portion.

According to some embodiments, the first portion of the first acquisition process includes a frequency scanning stage and a PSC determination stage. The frequency scanning stage includes at least a frequency band raw scanning phase and a fine scanning phase based on a center frequency. The PSC determination stage includes at least a slot synchronization phase using a primary synchronization channel (P-SCH), a code group and frame timing phase using a secondary synchronization channel (S-SCH), and a PSC identification phase using common pilot channel (CPICH).

In further embodiments, the first portion of the first acquisition process further includes a frequency pull-in stage, a PCCPCH transmission time interval (TTI) synchronization stage, system information reading stage, and cell selection stage. The frequency pull-in stage includes a multipath searching phase and rake receiver to multipath phase.

In some embodiments, the method further includes storing the at least one parameter in a memory storage and retrieving the at least one parameter from the memory storage for executing the second portion of the second acquisition process.

In further embodiments, the at least one parameter is stored in response to the completion of the first acquisition process.

In still further embodiments, the at least one parameter is retrieved in response to determining that a first PLMN associated with the first subscription and a second PLMN associated the second subscription are the same.

According to some embodiments, the second portion of the second acquisition process includes a multipath searching phase, a rake receiver to multipath phase, and a cell selection phase.

Embodiments relate to a UE configured for managing acquisitions, including a processor, the processor configured to execute a first portion of a first acquisition process for acquiring service for a first subscription of the UE. The process is also configured to obtain at least one parameter as a result of executing the first portion of the first acquisition process. The processor is further configured to execute a second portion of a second acquisition process for acquiring service for a second subscription of the UE using the at least one parameter.

The UE further includes a first SIM associated with the first subscription and a second SIM associated with the second subscription.

In some embodiments, the first subscription and the second subscription are associated with a same RAT.

In various embodiments, the first subscription and the second subscription are associated with a same PLMN.

In some embodiments, the executing the second portion of the second acquisition process includes: determining a PLMN associated with each of the first subscription and the second subscription; and executing the second portion of the second acquisition process based on the at least one parameter when the PLMN associated with the first subscription and the PLMN associated with the second subscription are the same.

In some embodiments, the at least one parameter is at least one of frequency, PSC, frame timing, or system information.

In some embodiments, the second portion of the second acquisition process includes at least a frequency pull-in stage and one of the at least one parameter is used in the frequency pull-in stage.

In some embodiments, the frequency pull-in stage includes at least a multipath searching phase and a pulling-in phase and one of the at least one parameter is used in the multipath searching phase.

In various embodiments, the second acquisition process includes only the second portion.

In some embodiments, the first portion of the first acquisition process includes a frequency scanning stage and a PSC determination stage. The frequency scanning stage includes at least a frequency band raw scanning phase and a fine scanning phase based on a center frequency. The PSC determination stage includes at least a slot synchronization phase using a P-SCH, a code group and frame timing phase using a S-SCH, and a PSC identification phase using CPICH.

In some embodiments, the UE further includes a memory storage. The processor is further configured to store the at least one parameter in the memory storage and retrieve the at least one parameter from the memory storage for executing the second portion of the second acquisition process.

In various embodiments, the at least one parameter is retrieved in response to determining that a first PLMN associated with the first subscription and a second PLMN associated the second subscription are the same.

In various embodiments, a non-transitory computer readable-medium is described, the non-transitory computer readable-medium containing instructions such that, when executed, causes a processor to execute a first portion of a first acquisition process for acquiring service for a first subscription of the UE, obtain at least one parameter as a result of executing the first portion of the first acquisition process, and execute a second portion of a second acquisition process for acquiring service for a second subscription of the UE using the at least one parameter.

In some embodiments, the processor executes the second portion of the second acquisition process by determining a PLMN associated with each of the first subscription and the second subscription and executing the second portion of the second acquisition process based on the at least one parameter when the PLMN associated with the first subscription and the PLMN associated with the second subscription are the same.

In various embodiments, a system for managing acquisitions, the system including means for executing a first portion of a first acquisition process for acquiring service for a first subscription of the UE, means for obtaining at least one parameter as a result of executing the first portion of the first acquisition process, and means for executing a second portion of a second acquisition process for acquiring service for a second subscription of the UE using the at least one parameter.

### BRIEF DESCRIPTION OF THE DRAWINGS

The accompanying drawings, which are incorporated herein and constitute part of this specification, illustrate exemplary embodiments of the disclosure, and together with the general description given above and the detailed description given below, serve to explain the features of the various embodiments.

FIG. 1 is a schematic diagram of a communication system in accordance with various embodiments.

FIG. 2 is a component block diagram of an example of a user device (UE) according to various embodiments.

FIG. 3 is a process flowchart diagram illustrating an example of an acquisition process according to various embodiments.

FIG. 4 is a process flowchart diagram illustrating an example of an acquisition process according to various embodiments.

FIG. 5 is a process flowchart diagram illustrating an example of an acquisition process according to various embodiments.

FIG. 6 is a process flowchart diagram illustrating an example of a Wideband Code Division Multiple Access (WCDMA) acquisition process according to various embodiments.

FIG. 7 is a schematic diagram illustrating an example of the acquisition processes in a multi-SIM context according to some embodiments.

FIG. 8A is a process flowchart diagram illustrating an example of a process according to various embodiments.

FIG. 8B is a process flowchart diagram illustrating an example of a process according to various embodiments.

FIG. 9 is a component block diagram of a user equipment suitable for use with various embodiments.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the disclosure or the claims.

Some modern communication devices, referred to herein as a user equipment (UE) or mobile station (MS), may include any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices. Such devices may include at least one SIM, a programmable processor, memory, and circuitry for connecting to two or more mobile communication networks simultaneously.

A UE may include one or more subscriber identity modules (SIMs) that provide users of the UEs with access to one or multiple separate mobile communication networks. The mobile communication networks are supported by radio access technologies (RATs). Examples of UEs include, but are not limited to, mobile phones, laptop computers, smart phones, and other mobile communication devices of the like that are configured to connect to one or more RATs. Examples of RATs include, but are not limited to, Frequency Division Multiple Access (FDMA), Time Division Multiple Access (TDMA), Code Division Multiple Access (CDMA), Universal Mobile Telecommunications Systems (UMTS) (particularly, Wideband Code Division Multiple Access (WCDMA), Long Term Evolution (LTE), and the like), Global System for Mobile Communications (GSM), General Packet Radio Service (GPRS), Wi-Fi, Personal Communications Service (PCS), or other protocols that may be used in a wireless communications network or a data communications network.

A UE provided with a plurality of SIMs and connected to two or more separate (or same) RATs using a same set of transmission hardware (e.g., radio-frequency (RF) transceivers) is a multi-SIM-multi-standby (MSMS) communication device. In one example, the MSMS communication device may be a dual-SIM-dual-standby (DSDS) communication device, which may include two SIM cards/subscriptions that may both be active on standby, but one is deactivated when the other one is in use. In another example, the MSMS communication device may be a triple-SIM-triple-standby (TSTS) communication device, which includes three SIM cards/subscriptions that may all be active on standby, where two may be deactivated when the third one is in use. In other examples, the MSMS communication device may be other suitable multi-SIM communication devices, with, for example, four or more SIMs, such that when one is in use, the others may be deactivated.

On the other hand, a UE that includes a plurality of SIMs and connects to two or more separate (or same) RATs using two or more separate sets of transmission hardware is termed a multi-SIM-multi-active (MSMA) communication device. An example MSMA communication device is a dual-SIM-dual-active (DSDA) communication device, which includes two SIM cards/subscriptions. Both SIMs may remain active. In another example, the MSMA device may be a triple-SIM-triple-active (TSTA) communication device, which includes three SIM cards/subscriptions. All three SIMs may remain active. In other examples, the MSMA communication device may be other suitable multi-SIM communication devices with four or more SIMs, for which that all SIMs may be active.

Embodiments described herein relate to a multi-SIM context, such as, but not limited to, the MSMS and MSMA contexts. For example, in the multi-SIM context, each subscription may be configured to acquire service from a base station (associated with a given cell).

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service with a particular network, the term “SIM” may also be used herein as a shorthand reference to the communication service associated with and enabled by the information (e.g., in the form of various parameters) stored in a particular SIM as the SIM and the communication network, as well as the services and subscriptions supported by that network, correlate to one another.

Embodiments described herein relate to both MSMA and MSMS UEs, where two or more of the subscriptions would locate and link to a same serving cell after respective service acquisition processes. For clarity, systems and processes described refer to two subscriptions. However, a UE with three or more subscriptions may implement systems and methods described in similar manners. Both subscriptions may be associated with a same RAT. In a non-limiting example, systems and methods may be implemented with a MSMS or MSMA UE having a first subscription and a second subscription, each of which may be associated with WCDMA. Both subscriptions may be associated with a same public land mobile network (PLMN). Accordingly, both subscriptions may find a same cell when both subscriptions are associated with a same PLMN. The PLMN may be a function of a mobile country code (MCC) and mobile network code (MNC), as stored on a SIM.

A subscription acquisition process (e.g., a WCDMA acquisition process) may include multiple phases such as, but not limited to:

A) raw scan on a WCDMA frequency band;

B) fine scan on a center frequency;

C) slot synchronization using a primary synchronization channel (P-SCH);

D) code group and frame timing using a secondary synchronization channel (S-SCH);

E) primary scrambling code (PSC) identification using common pilot channel (CPICH);

F) PN search in which a multipath is found (also known as a multipath searching phase);

G) pulling-in which reconfirms the searcher peaks using a rake receiver (also known as a rake receiver to multipath phase);

H) decoding a primary common control physical channel (PCCPCH) and aligning figure transmission time interval (TTI) (also known as a PCCPCH TTI synchronization phase);

I) system information reading phase; and

J) cell selection phase.

The phases delineated above may be grouped into separate stages. For example, phases A and B may be in a frequency scanning stage. Phases C-E may be in a PSC determination stage. Phases F and G may be in a frequency pull-in stage. Phases H, I and J may each be a stage in and of itself

The UE may include one or more RF resources configured to perform acquisition processes for the first subscription (e.g., a first acquisition process) and for the second subscription (e.g., a second acquisition process). In some embodiments, at least a portion of each of the first acquisition process and the second acquisition process may take place simultaneously. In other embodiments, the first acquisition process and the second acquisition process may occur sequentially.

In some embodiments, first, the UE may perform a first acquisition process including each of the phases (phases A-J) or stages (the frequency scanning stage, the PSC determination stage, the frequency pull-in stage, the PCCPCH TTI synchronization stage, the system information reading stage, and the cell selection stage). The UE may store one or more or all of frequency, PSC, frame timing, and system information determined in the first acquisition for the first subscription.

Next, the UE may determine whether the first subscription and the second subscription are associated with a same PLMN. Such determination reveals whether the first subscription and the second subscription would receive service from a same service cell.

If the PLMN of the subscriptions are the same, the UE may initiate the second acquisition process at the frequency pull-in stage (i.e., at phase F) instead of at the frequency scanning stage (phases A and B). For example, the UE may perform F, the multipath search phase; G, the rake receiver to multipath phase, and J, the cell selection phase using the at least one parameter stored.

In other embodiments, first, the UE may perform a frequency scanning stage (i.e., phases A and B) and a PSC determination stage (i.e., phases C-E) of the first acquisition process. A PSC may be obtained as a result of the PSC determination stage. Specifically, the PSC is identified using the CPICH at phase E. The UE may use the PSC to acquire slot synchronization to a serving cell, for example, with a filter matched to the PSC. The determined PSC may be stored in memory for future access.

Subsequently, the UE may determine whether the first subscription and the second subscription are associated with a same PLMN. Such determination reveals whether the first subscription and the second subscription would receive service from a same service cell.

If the PLMN of the subscriptions are the same, the UE may initiate the second acquisition process at the frequency pull-in stage (i.e., at phase F) instead of at the frequency scanning stage (phases A and B). The UE may access the stored PSC and use it to perform phases F-G of the second acquisition process. Next, phases H-J may be performed in the second acquisition process.

Accordingly, the second acquisition process may forgo stages or phases as long as at least one appropriate parameter, such as, but not limited to, frequency, PSC, frame timing, and system information, each obtained from the first acquisition process, is made accessible for the second acquisition process.

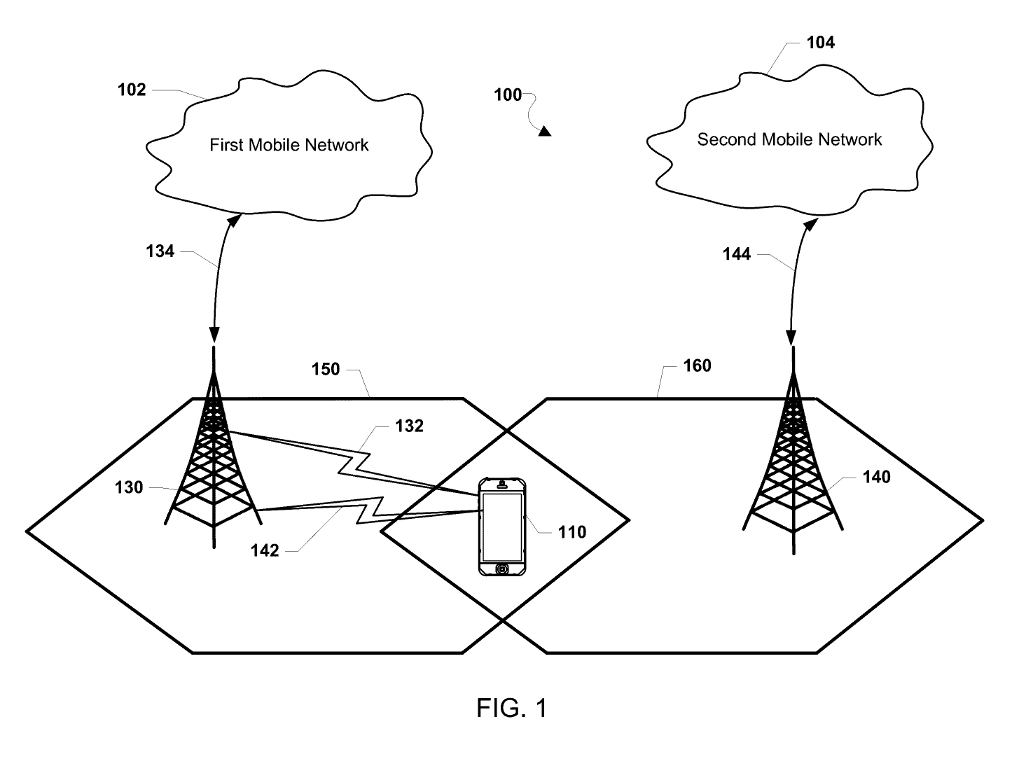

Various embodiments may be implemented within a communication system 100, an example of which is illustrated in FIG. 1. A first mobile network 102 and a second mobile network 104 typically each includes a plurality of cellular base stations (e.g., a first base station 130 and a second base station 140). The first base station 130 may broadcast the first mobile network 102 in a first serving cell 150. The second base station 140 may broadcast the second mobile network 104 in a second serving cell 160. A UE 110 may acquire cell service from either the first serving cell 150 or the second serving cell 160.

The UE 110 may be in communication with the first mobile network 102 through a first cellular connection 132 to the first base station 130. The first cellular connection 132 may correspond to a first subscription of the UE 110. The UE 110 may also be in communication with the first mobile network 102 through a second cellular connection 142 to the first base station 130. The second cellular connection 142 may correspond to a second subscription of the UE 110, as in a multi-SIM context. For example, both the first subscription and the second subscription may locate a same serving cell (e.g., the first serving cell 150). The UE 110 may not be in communication with the second mobile network 104 through any cellular connection to the second base station 140. The first base station 130 may be in communication with the first mobile network 102 over a wired or wireless connection 134. The second base station 140 may be in communication with the second mobile network 104 over a wired or wireless connection 144.

The first cellular connection 132 and the second cellular connection 142 may be made through two-way wireless communication links. Each of the wireless communication links may be enable by FDMA, TDMA, CDMA, UMTS (particularly, WCDMA, LTE, and the like), GSM, GPRS, Wi-Fi, PCS, or another protocol used in a wireless communications network or a data communications network. By way of illustrating with a non-limiting example, the first cellular connection 132 and the second cellular connection 142 may each be a WCDMA subscription. In some embodiments, the first cellular connection 132 and the second cellular connection 142 may each be associated with a different RAT. In other embodiments, the first cellular connection 132 and the second cellular connection 142 may be associated with a same RAT.

Each of the first base station 130 and the second base station 140 may include at least one antenna group or transmission station located in the same or different areas. The at least one antenna group or transmission station may be associated with signal transmission and reception. Each of the first base station 130 and the second base station 140 may include one or more processors, modulators, multiplexers, demodulators, demultiplexers, antennas, and the like for performing the functions described herein. In some embodiments, the first base station 130 and the second base station 140 may be an access point, Node B, evolved Node B (eNode B or eNB), base transceiver station (BTS), or the like.

In various embodiments, the UE 110 may be configured to access the first mobile network 102 by virtue of the multi-SIM and/or the multi-mode SIM configuration of the UE 110 (e.g., via the first cellular connection 132 and the second cellular connection 142). When a SIM corresponding to a subscription is received, the UE 110 may access the mobile communication network associated with that subscription based on the information stored on the SIM.

While the UE 110 is shown connected to the mobile network 102 via two cellular connections, in some embodiments (not shown), the UE 110 may establish additional cellular connections associated with additional subscriptions corresponding to the mobile network 102 in a manner similar to those described above.

In some embodiments, the UE 110 may establish a wireless connection with a peripheral device (not shown) used in connection with the UE 110. For example, the UE 110 may communicate over a Bluetooth® link with a Bluetooth-enabled personal computing device (e.g., a “smart watch”). In some embodiments, the UE 110 may establish a wireless connection with a wireless access point (not shown), such as over a Wi-Fi connection. The wireless access point may be configured to connect to the Internet or another network over a wired connection.

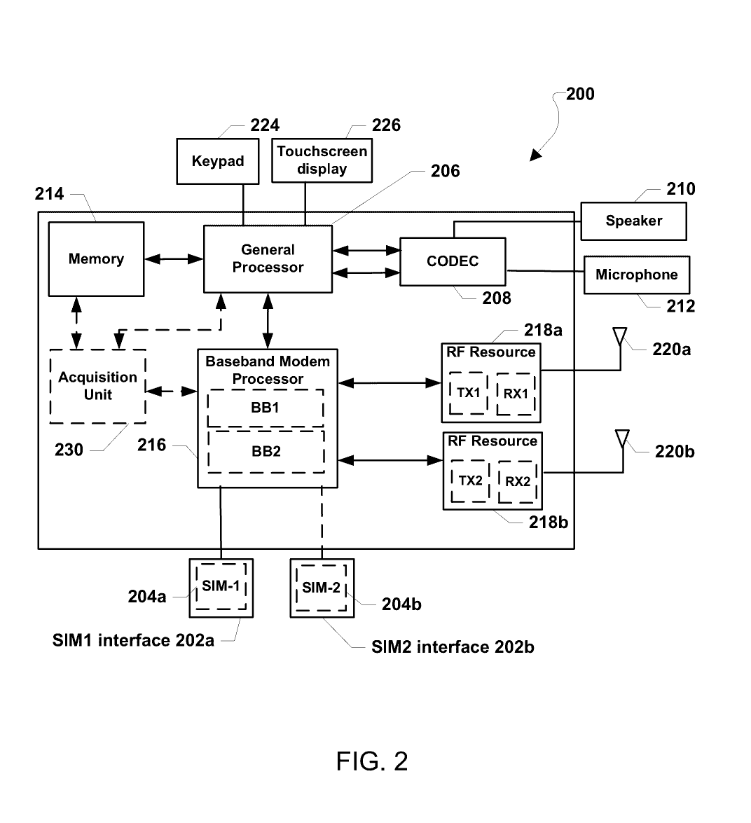

FIG. 2 is a functional block diagram of an UE 200 suitable for implementing various embodiments. According to various embodiments, the UE 200 may be the UE 110 as described with reference to FIG. 1. Referring to FIGS. 1-2, the UE 200 may include a first SIM interface 202a, which may receive a first identity module SIM-1 204a that is associated with the first subscription. The UE 200 may also include a second SIM interface 202b, which may receive a second identity module SIM-2 204b that is associated with the second subscription. In some embodiments, the first subscription may be different from the second subscription. In other embodiments, the first subscription may be a same subscription as the second subscription.

A SIM in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the UE 200, and thus need not be a separate or removable circuit, chip, or card.

A SIM used in various embodiments may store user account information, an IMSI, a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The UE 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The general-purpose processor 206 may include any suitable data processing device, such as a microprocessor. In the alternative, the general-purpose processor 206 may be any suitable electronic processor, controller, microcontroller, or state machine. The general-purpose processor 206 may also be implemented as a combination of computing devices (e.g., a combination of a digital signal processor (DSP) and a microprocessor, a plurality of microprocessors, at least one microprocessors in conjunction with a DSP core, or any other such configuration).

The memory 214 may be a non-transitory processor-readable storage medium that stores processor-executable instructions. For example, the instructions may include routing communication data relating to the first or second subscription though a corresponding baseband-RF resource chain. The memory 214 may include any suitable internal or external device for storing software and data. Examples of the memory 214 may include, but are not limited to, random access memory RAM, read only memory ROM, floppy disks, hard disks, dongles or other recomp sensor board (RSB) connected memory devices, or the like. The memory 214 may store an operating system (OS), user application software, and/or executable instructions. The memory 214 may also store application data, such as an array data structure.

The general-purpose processor 206 and the memory 214 may each be coupled to at least one baseband modem processor 216. Each SIM in the UE 200 (e.g., the SIM-1 202a and the SIM-2 202b) may be associated with a baseband-RF resource chain. A baseband-RF resource chain may include the baseband modem processor 216, which may perform baseband/modem functions for communications on at least one SIM, and may include one or more amplifiers and radios, referred to generally herein as RF resources 218a, 218b (e.g., the first RF resource 218a and the second RF resource 218b). In some embodiments, baseband-RF resource chains may share the baseband modem processor 216 (i.e., a single device that performs baseband/modem functions for all SIMs on the UE 200). In other embodiments, each baseband-RF resource chain may include physically or logically separate baseband processors (e.g., BB1, BB2).

The RF resources 218a, 218b may each be transceivers that perform transmit/receive functions for the associated SIMs 204a, 204b of the UE 200. The RF resources 218a, 218b may include separate transmit and receive circuitry, or may include a transceiver that combines transmitter and receiver functions. The RF resources 218a, 218b may each be coupled to a wireless antenna (e.g., a first wireless antenna 220a or a second wireless antenna 220b). The RF resources 218a, 218b may also be coupled to the baseband modem processor 216.

For simplicity, the first RF resource 218a (as well as the associated components) may be associated with the first subscription as enabled by the SIM-1 202a. For example, the first RF resource 218a may be configured to transmit/receive data via the first cellular connection 132. The second RF resource 218b may be associated with the second subscription as enabled by the SIM-2 202b. For example, the second RF resource 218b may be configured to transmit/receive data via the second cellular connection 142.

In some embodiments, the general-purpose processor 206, the memory 214, the baseband processor(s) 216, and the RF resources 218a, 218b may be included in the UE 200 as a system-on-chip. In some embodiments, the first and second SIMs 202a, 202b and their corresponding interfaces 204a, 204b may be external to the system-on-chip. Further, various input and output devices may be coupled to components on the system-on-chip, such as interfaces or controllers. Example user input components suitable for use in the UE 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the UE 200 to enable communication between them, as is known in the art.

In some embodiments (not shown), the UE 200 may include, among other things, additional SIM cards, SIM interfaces, a plurality of RF resources associated with the additional SIM cards, and additional antennae for connecting to additional mobile networks.

The UE 200 may include an acquisition unit 230 configured to manage and/or schedule utilization of the RF resources 218a, 218b for acquisition processes. For example, the acquisition unit 230 be configured perform acquisition processes for the first subscription and the second subscription, in the manner described.

In some embodiments, the acquisition unit 230 may be implemented within the general-purpose processor 206. For example, the acquisition unit 230 may be implemented as a software application stored within the memory 214 and executed by the general-purpose processor 206. Accordingly, such embodiments can be implemented with minimal additional hardware costs. However, other embodiments relate to systems and process that are implemented with dedicated device hardware specifically configured for performing operations described herein. For example, the acquisition unit 230 may be implemented as a separate hardware component (i.e., separate from the general-purpose processor 206). The acquisition unit 230 may be coupled to the memory 214, the general processor 206, and/or the baseband processor 216 for performing the function described herein. The acquisition unit 230 may include (or coupled to) at least one of a radio resource control (RRC) layer, a radio resource management (RR) layer, a radio link control (RLC) layer, a media access control (MAC) layer, a physical layer, and the like.

Hardware and/or software for the functions may be incorporated in the UE 200 during manufacturing, for example, as part of the original equipment manufacturer's (“OEM's”) configuration of the UE 200. In further embodiments, such hardware and/or software may be added to the UE 200 post-manufacture, such as by installing one or more software applications onto the UE 200.

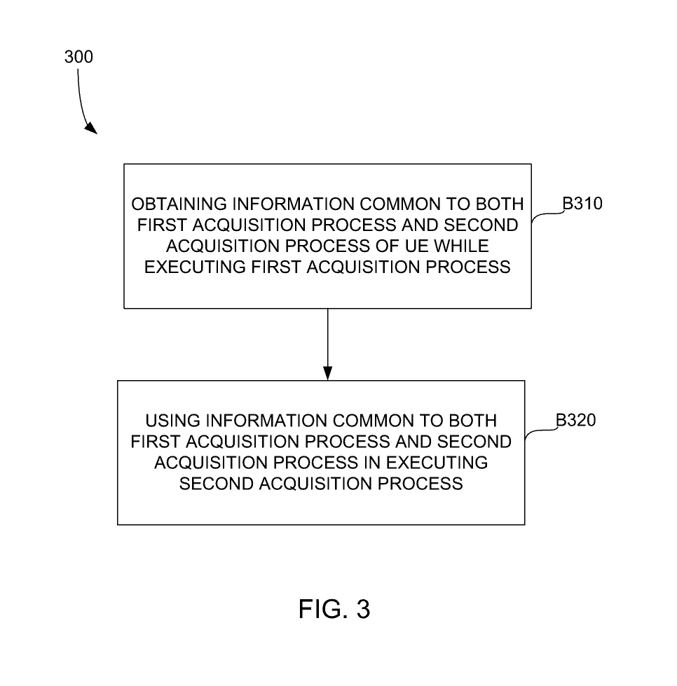

FIG. 3 is a process flowchart diagram illustrating an example of an acquisition process 300 according to various embodiments. Referring to FIGS. 1-3, the acquisition process 300 may be performed by the acquisition unit 230 of the UE 200 according to some embodiments. The acquisition process 300 may be implemented to effectively acquire services for two subscriptions in the manner described.

At block B310, the acquisition unit 230 may obtain (or otherwise determine) information common to both the first acquisition process and the second acquisition process of the UE while executing the first acquisition process. In a multi-SIM context, two or more SIMs of the same UE may enable two or more subscriptions for the UE. In various scenarios, both subscriptions may eventually acquire service from a same serving cell (e.g., the first serving cell 150) via connections (e.g., the first cellular connection 132 and the second cellular connection 142). Therefore, information common to both the first acquisition process and the second acquisition process may be shared between the first acquisition process and the second acquisition process.

For example, serving cell identification information may be shared between the first acquisition process and the second acquisition process when it is determined that the first subscription and the second subscription may acquire service for a same serving cell (e.g., the first serving cell 150). The serving cell identification information may include one or more or all of frequency, PSC, frame timing, system information, and/or the like. Illustrating with a non-limiting example, the serving cell identification information may be a PSC, which identifies different WCDMA serving cells in downlink. When the PSC is obtained in first acquisition process, the PSC may be made available for frequency pull-in for the second acquisition process.

Next at block B320, the acquisition unit 230 may use the information common to both the first acquisition process and the second acquisition process in executing the second acquisition process. For example, when the serving cell identification information (e.g., PSC) common to both acquisition processes is obtained in the first acquisition process already, the acquisition unit 230 may execute the second acquisition process directly using the obtained serving cell identification information. In other words, the acquisition unit 230 may not need to execute phases of the second acquisition process to obtain the same serving cell identification information.

In particular, where in the information common to both the first acquisition process and the second acquisition process may be all of the frequency, PSC, frame timing, and system information, the second acquisition process may not need to execute the following phases: raw scan on a WCDMA frequency band (A); fine scan on a center frequency (B); slot synchronization using a P-SCH (C); code group and frame timing using a S-SCH (D); PSC identification using CPICH (E); PCCPCH TTI synchronization phase (H); and system information reading phase (I). That is, the second acquisition process may skip the frequency scanning stage or the PSC determination stage, and begin at the frequency pull-in stage and end at the cell selection stage (J). The second acquisition process may also skip PCCPCH TTI Synchronization and system information reading, given that the outcome of each of the phases had already been determined by the first acquisition process.

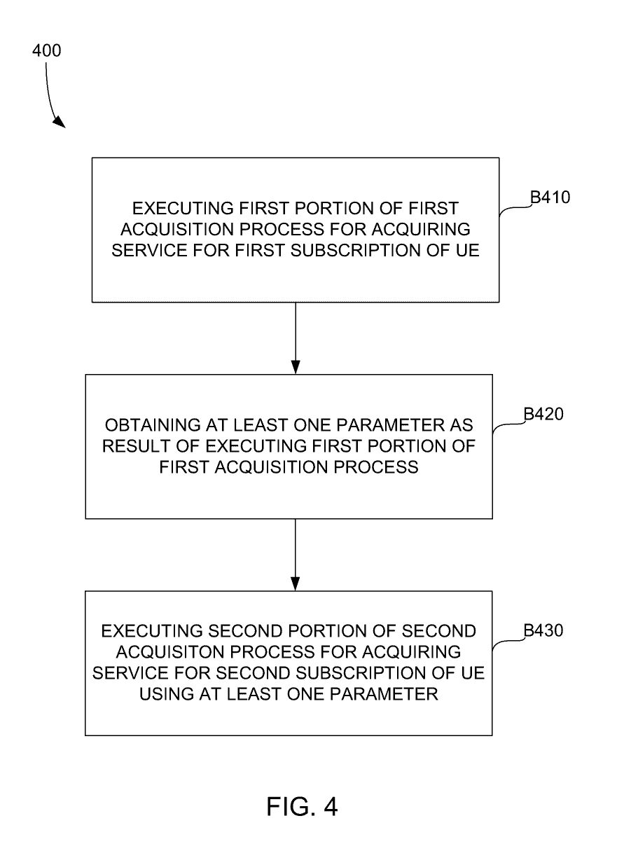

FIG. 4 is a process flowchart diagram illustrating an example of an acquisition process 400 according to various embodiments. Referring to FIGS. 1-4, the acquisition process 400 may be performed by the acquisition unit 230 of the UE 200 according to some embodiments. The acquisition process 400 may be particular implementations of the acquisition process 300. In particular, blocks B410-B420 may correspond to block B310, and block B430 may correspond to block B320.

At block B410, the acquisition unit 230 may execute a first portion of a first acquisition process for acquiring service for the first subscription of the UE. The first subscription and the second subscription may be provided to the UE. The first subscription and the second subscription may be associated with a same RAT. Next at block B420, the acquisition unit 230 may obtain at least one parameter as a result of executing the first portion of the first acquisition process. The at least one parameter may be one or more of frequency, PSC, frame timing, and system information, each associated with the first subscription.

At block B430, the acquisition unit may execute a second portion of the second acquisition process for acquiring service for the second subscription of the UE using the at least one parameter. Illustrating with a non-limiting example, the second portion of the second acquisition process may include, but not limited to, determining the PLMN associated with each of the first subscription and the second subscription, and executing the second portion of the second acquisition process based on the parameter when the PLMN associated with the first subscription and the PLMN associated with the second subscription are the same. The second portion of the second acquisition process may include, for example, a frequency pull-in stage, where the parameter is used in the frequency pull-in stage. The frequency pull-in stage may include at least a multipath searching phase and rake receiver to multipath phase. The second acquisition process may only include the second portion. A first portion of the second acquisition process, which may be corresponding to the first portion of the first acquisition process, may be forgone.

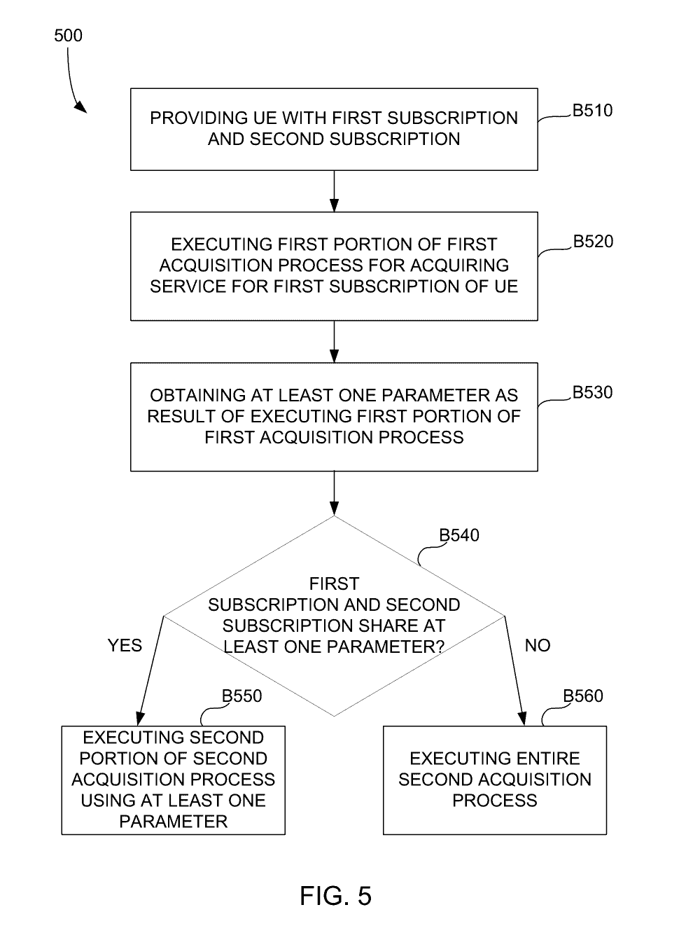

FIG. 5 is a process flowchart diagram illustrating an example of an acquisition process 500 according to various embodiments. Referring to FIGS. 1-5, the acquisition process 500 may be performed by the acquisition unit 230 of the UE 200 according to some embodiments. The acquisition process 500 may be particular implementations of the acquisition process 300. In particular, blocks B510-B530 may correspond to block B310, and blocks B540-550 may correspond to block B320.

At block B510, the UE 200 may be provided with the first subscription and the second subscription. The first subscription may be enabled by information stored on a first SIM (e.g., SIM-1 204a) provided to the UE 200. The second subscription may be enabled by information stored on a second SIM (e.g., SIM-2 204b) provided to the UE 200.

Next at block B520, the acquisition unit 230 may execute a first portion of the first acquisition process for acquiring service for a first subscription of the UE. In various embodiments, the first portion of the first acquisition process may include phases for obtaining at least one parameter (e.g., the information common to both the first acquisition process and the second acquisition process) shared between the first acquisition process and the second acquisition process.

Next at block B530, the acquisition unit 230 may obtain the at least one parameter as a result of executing the first portion of the first acquisition process. An example of the parameter may include, but not limited to, frequency, PSC, frame timing, and system information associated with a serving cell. Illustrating with a non-limiting example, the PSC may be determined at the PSC determination stage of the first portion. In particular, the PSC may be determined using the CPICH. The at least one parameter may be stored in the memory 214 or other suitable memory devices after being obtained in the first acquisition process.

Next at block B540, the acquisition unit 230 may determine whether the first subscription and the second subscription share (or could share) the parameter. For instance, the acquisition unit 230 may determine whether the first subscription and the second subscription will camp on a same network (e.g., the first mobile network 102) provided in a same serving cell (e.g., the first serving cell 150).

In various embodiments, the first subscription and the second subscription may both be a WCDMA subscription having a same PLMN. The PLMN may be a value for identifying a terrestrial subscriber network. In such embodiments, the first subscription and the second subscription may be determined to share the parameter when they have the same PLMN.

In some embodiments, the determination at block B540 may be made prior to storing the at least one parameter. In other embodiments, the determination at block B540 may be made after storing the at least one parameter. In various embodiments, the acquisition unit 230 may determine whether the first subscription and the second subscription should share the at least one parameter after at least one of the SIMs corresponding to either the first subscription and the second subscription (e.g., SIM-1 204a, SIM-2 204b, and/or the like) are first inserted into the UE 200. The result of the determination may be stored in the memory 214. In such cases, determining whether the first subscription and the second subscription would share the at least parameter may include accessing the memory 214 for the result of the determination made previously.

Whereas the acquisition unit 230 determines that the at least one parameter is (or could be) shared, the acquisition unit 230 may execute a second portion of the second acquisition process using the at least one parameter, at block B550 (B540:YES). For example, the acquisition unit 230 may retrieve the stored parameter in the memory 214 or other suitable memory devices for using in the second portion of the second acquisition process. Given that the at least one parameter may be the same for the second acquisition process, the at least one parameter may be directly used, without laboring to perform a first portion of the second acquisition process. The first portion of the second acquisition process may include phases of the first portion of the first acquisition process. For example, the first portion of the second acquisition process would be otherwise executed prior to the second portion and include at least the raw scan on a WCDMA frequency band (A); fine scan on a center frequency (B); slot synchronization using a P-SCH (C); code group and frame timing using a S-SCH (D); and PSC identification using CPICH (E). In further embodiments, the first portion of the second acquisition process may also include the PCCPCH TTI synchronization phase (H) and the system information reading phase (I). The first portion of the second acquisition process may not need to be executed when the parameter may be shared (as determined at block B540)

On the other hand, whereas the acquisition unit 230 determines that the at least one parameter could not be shared, the acquisition unit 230 may execute an entire second acquisition process from the beginning, at block B560 (B540:NO). For example, the acquisition unit 230 may initiate the first portion of the second acquisition process and obtain new parameters that may be different from the at least one parameter determined at block B530. The new parameters may then be used in the second portion of the second acquisition process.

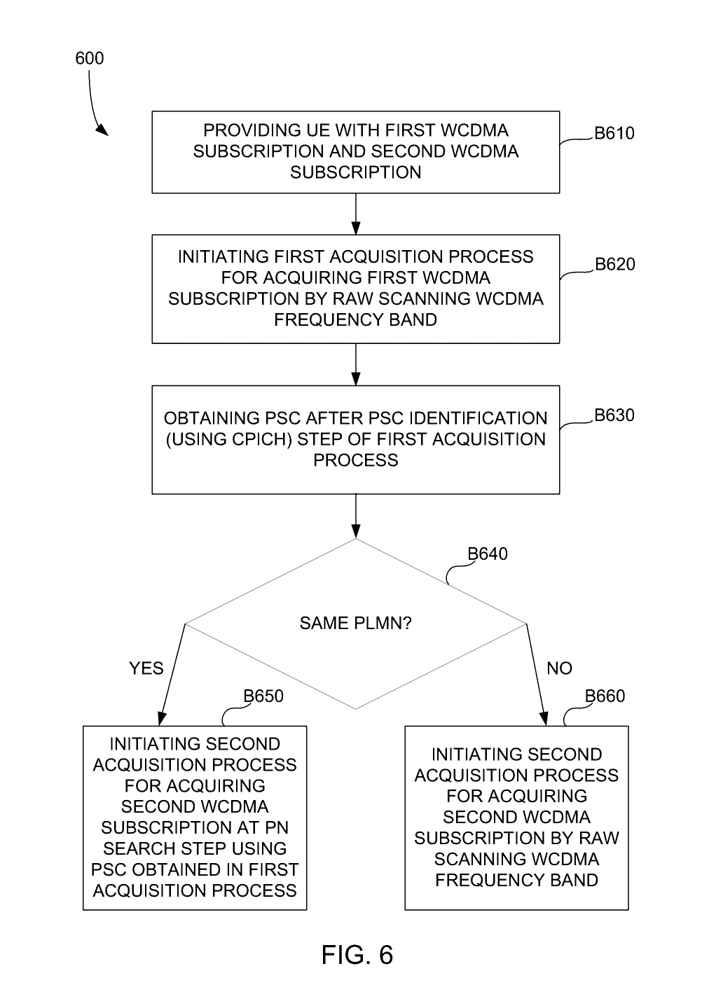

FIG. 6 is a process flowchart diagram illustrating an example of a WCDMA acquisition process 600 according to various embodiments. Referring to FIGS. 1-6, the WCDMA acquisition process 600 may be performed by the acquisition unit 230 of the UE 200 according to some embodiments. The WCDMA acquisition process 600 may be particular implementations of the acquisition process 300. In particular, blocks B610-B630 may correspond to block B310. Blocks B640-650 may correspond to block B320. In addition, the WCDMA acquisition process 600 may correspond to the acquisition process 400. In particular, each of blocks B610-B660 may correspond to each of blocks B510-560, respectively.

At block B610, the UE 200 may be provided with the first WCDMA subscription and the second WCDMA subscription. The first WCDMA subscription may be enabled by information stored on a first SIM (e.g., SIM-1 204a) provided to the UE. The second WCDMA subscription may be enabled by information stored on a second SIM (e.g., SIM-2 204b) provided to the UE 200.

Next at block B620, the acquisition unit 230 may initiate a first acquisition process for acquiring the first WCDMA subscription by raw scanning the WCDMA frequency band. After raw scanning is completed, the acquisition unit 230 may then proceed with fine scanning based on a center frequency, slot synchronization using the P-SCH, code group and frame timing using the S-SCH, and PSC identification using CPICH.

Next at block B630, the acquisition unit 230 may obtain the PSC after the PSC identification (using the CPICH) phase of the first acquisition process. The PSC may be stored in the manner described.

Next at block B640, the acquisition unit 230 may determine whether the first WCDMA subscription and the second WCDMA subscription are associated with a same PLMN. For example, the acquisition unit 230 may determine the PLMN for each of the first WCDMA subscription and the second WCDMA subscription by accessing the MCC and/or the MNC stored on the SIMs (e.g., SIM-1 204a and SIM-2 204b). The acquisition unit 230 may then compare the PLMNs associated with either the first WCDMA subscription and the second WCDMA subscription to determine whether the PLMNs are the same.

Whereas the acquisition unit 230 determines the PLMNs are the same, the acquisition unit 230 may initiate the second acquisition process for acquiring the second WCDMA subscription at the PN search phase using the PSC obtained in the first acquisition proves, at block B650 (B640:YES). That is, the second acquisition process is initiated at an interim phase with the PSC obtained from the first acquisition process, instead of initiating at the raw scanning phase. In addition, phases between the raw scanning phase and the PN search phase (i.e., fine scanning based on a center frequency, slot synchronization using the P-SCH, code group and frame timing using the S-SCH, and PSC identification using CPICH) may not need to be executed. In other words, the second acquisition phase may be initiated at the PN search phase and proceed with the frequency pull-in phase, the PCCPCH decoding phase, and the cell selection phase.

On the other hand, whereas the acquisition unit 230 determines that the PLMNs are not the same, the acquisition unit 230 initiate the second acquisition process for acquiring the second WCDMA subscription at the raw scanning phase B660 (B640:NO). For example, the second acquisition process may, in this case, include the frequency scanning stage, the PSC determination stage, the frequency pull-in stage, the PCCPCH decoding stage, and the cell selection phase.

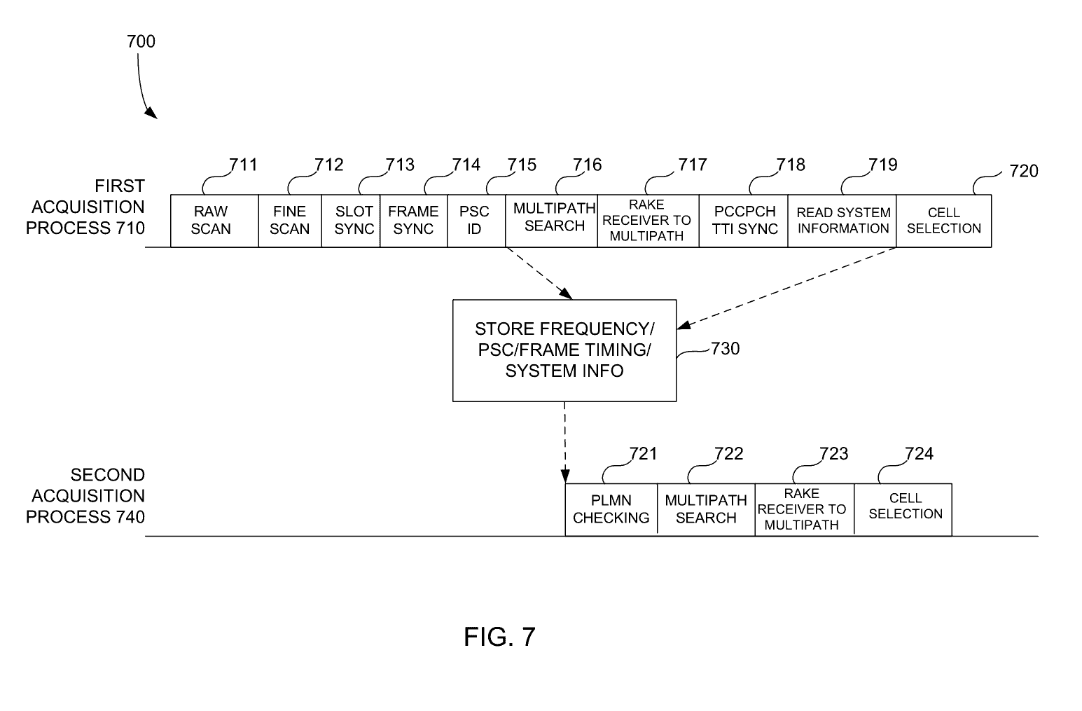

FIG. 7 is an example of a schematic diagram 700 illustrating an example of the acquisition processes in a multi-SIM context. For example, the diagram 700 may correspond to the acquisition process 300, the acquisition process 400, processes 800a, 800b, and/or the like. In particular, the diagram 700 may illustrate an example for which the at least one parameter (e.g., frequency, PSC, frame timing, and system information) may be shared (e.g., B540:YES and B820b:YES).

For example, the first acquisition process 710 may be initiated at the raw scan phase 711. Then the first acquisition process 710 may include the fine scan phase 712, the slot synchronization phase 713, the frame synchronization phase 714, and the PSC identification phase 715. After the PSC is obtained at the PSC identification phase 715 of the first acquisition process 710, the PSC, frequency, and frame timing may be stored at the storing phase 730. The first acquisition process 710 may continue with the multipath searching phase 716, the rake receiver to multipath phase 717, the PCCPCH TTI synchronization phase 718, the system information reading phase 719. After executing the system information reading phase 719, the system information may be stored at the storing phase 730. Next, the first acquisition process 710 may continue to the cell selection phase 720.

In some embodiments, the at least one parameter may be stored at a single storing phase 730 in response to obtaining the system information reading phase 719. In other embodiments, some of the at least one parameter (e.g., the frequency, the PSC, and frame timing) may be stored prior in time (e.g., immediately in response to being obtained) in a first storing phase while some other of the at least one parameter (e.g., the system information) may be stored subsequently in a second separate storing phase.

In response to the obtaining and/or the storing phase 730, the second acquisition process 740 is initiated at PLMN checking phase 721, in which the PLMNs are compared to determine whether they are the same (corresponding at block B540 or B830a). When it is determined that the PLMNs are the same, the second acquisition process 740 may continue with the multipath searching phase 722, the rake receiver to multipath phase 723, and the cell selection phase 724, using the stored at least one parameter. The phases of the second acquisition process 740 corresponding to the raw scan phase 711, the fine scan phase 712, the slot synchronization phase 713, the frame synchronization phase 714, the PSC identification phase 715, the PCCPCH TTI synchronization phase 718, and the system information reading phase 719 of the first acquisition process 710 may not be executed.

In some embodiments, the entire first acquisition process 710 may be executed, with all of the at least one parameter stored before the second acquisition process 740 initiates at the PLMN checking phase 721. In other embodiments, the second acquisition process 740 may be initiated as soon as one or more of the at least one parameter (obtained first in time) are determined and stored. For example, the second acquisition process 740 may be initiated at the PLMN checking phase 721 when one or more of the PSC, frequency, and frame timing are determined by the first acquisition process 710 or when one or more of the PSC, frequency, and frame timing are stored. When the system information becomes available at the system information reading phase 719 of the first acquisition process 710 (and/or stored at the storing phase 730), the system information may be stored when the second acquisition process 740 has yet to reach the cell selection phase 724. On the other hand, when the second acquisition process 740 had already reached the cell selection phase 724 before the system information reading phase 719 of the first acquisition process 710 is completed, the second acquisition process 740 may be paused until the system information becomes available at the end of the system information reading phase 719.

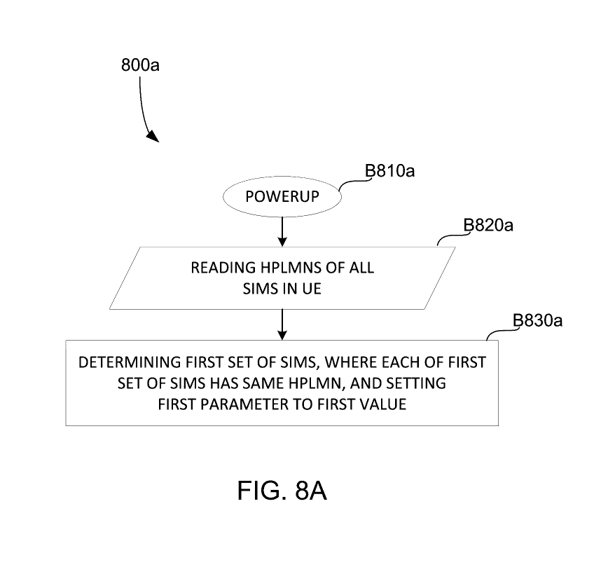

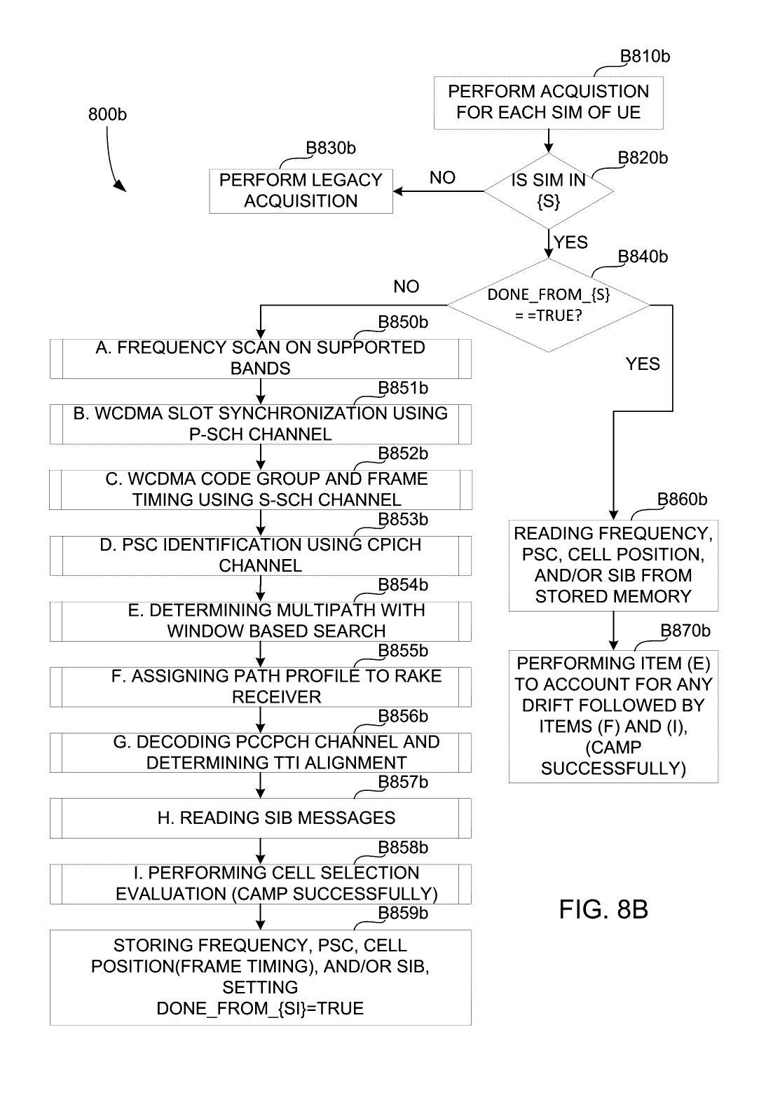

FIG. 8A is a process flowchart diagram illustrating an example of a process 800a according to various embodiments. Referring to FIGS. 1-8A, the process 800a may be performed by the acquisition unit 230 of the UE 200 according to some embodiments. First at block B810a, the UE 200 is powered up. Next at block B820a, the acquisition unit 230 of the UE 200 may read the home public land mobile network (HPLMN) parameter for all SIMs in the UE 200. The HPLMN may be used to identify the PLMN associated with each of the SIMs in the UE 200. The UE 200 may include (i.e., the acquisition unit 230 may detect) N number of SIMs (i.e., SIM 1, SIM 2, . . . , SIM N).

Next at block B830a, the acquisition unit 230 of the UE 200 may determine a first set of SIMs (e.g., {S}) based on the associated HPLMN parameter. For example, each of the first set of SIMs may have a same HPLMN parameter. The first set of SIMs may include K number of SIMs (i.e., S={SIM 1, SIM 2, . . . , SIM K}), where K is less than or equal to N. A first parameter (e.g., Done_From_{S}) may be set by the acquisition unit 230 of the UE 200 to a first value (e.g., “FALSE,” Done_From_{S}=FALSE).

FIG. 8B is a process flowchart diagram illustrating an example of a process 800b according to various embodiments. Referring to FIGS. 1-8B, the process 800b may be a WCDMA acquisition process performed by the acquisition unit 230 of the UE 200 according to some embodiments. The process 800b may be executed by the acquisition unit 230 of the UE 200 following the end (e.g., block B830a) of the process 800a.

At block B810b, the acquisition unit 230 may be configured to perform acquisition for each SIM provided in the UE 200. As described, the UE 200 may include the N number of SIMs. At block B820b, the acquisition unit 230 may determine whether the current SIM is one of SIMs in the first set {S}. If the current SIM for which acquisition is currently executed for is not in the first set (B820b:NO), the acquisition unit 230 may be configured to perform legacy acquisition for the current SIM at block B830b.

On the other hand, if the current SIM is in the first set (B820b:YES), the acquisition unit 230 may determine whether the first parameter is set to a second value (e.g., “TRUE,” Done_From_{S}==TRUE?), at block B840b. When the acquisition unit 230 determines that the first parameter is not set to the second value (e.g., Done_From_{S}=FALSE), the acquisition unit 230 may execute the acquisition/camping processes for the current SIM (associated with a current subscription/RAT) at blocks B850b-B858b. The first parameter may be set to the first value instead of the second value when acquisition process for any element of the first set has yet to be executed since the power up at block B810a.

The acquisition/camping processes for the current SIM may include items A-I as described. For example, the acquisition unit 230 may perform a frequency scan on supported frequency bands at block B850b (item A). Next, the acquisition unit 230 may perform WCDMA slot synchronization using P-SCH channel at block B851b (item B). Then, the acquisition unit 230 may perform WCDMA code group and frame timing using S-SCH channel at block B852b (item C). Next, the acquisition unit 230 may perform PSC identification using CPICH channel at block B853b (item D). The acquisition unit 230 may then determine a multipath with window based search at block B854b (item E). Next at block B855b (item F), the acquisition unit 230 may assign a path profile to a rake receiver. Next at block B856b (item G), the acquisition unit 230 may decode PCCPCH channel and determine TTI alignment. The acquisition unit 230 may read SIB messages at block B857b (item H). Then, at block B858b (item I), the acquisition unit 230 may perform cell selection and evaluation, upon completion of which the camping process is successfully completed.

Next, at block B859b, the acquisition unit 230 may store one or more or all of frequency, PSC, cell position (e.g., frame timing), and SIB information within the memory 214. In addition, the acquisition unit 230 may set the first parameter to the second value (e.g., setting Done_From_{S}=TRUE). Next, the acquisition unit 230 may execute another iteration of the process 800b for another SIM/subscription/RAT at block B820b, if there is any remaining SIM/subscription/RAT for which service has yet to be acquired.

When the acquisition unit 230 determines that the first parameter is set to the second value (e.g., Done_From_{S}=TRUE), the acquisition unit 230 may read the frequency, PSC, cell position, and SIB information from the stored memory (e.g., the memory 214), at block B860b (B840b:YES). Next at block B870b, the acquisition unit 230 may perform item E to account for any drift with the data read at block B860b. The acquisition unit 230 may then perform items F and I with the data read at block B860b. After performing item I, the acquisition/camping process is successfully completed for the current SIM/subscription/RAT. Next, the acquisition unit 230 may execute another iteration of the process 800b for another SIM/subscription/RAT at block B820b, if there is any remaining SIM/subscription/RAT for which service has yet to be acquired.

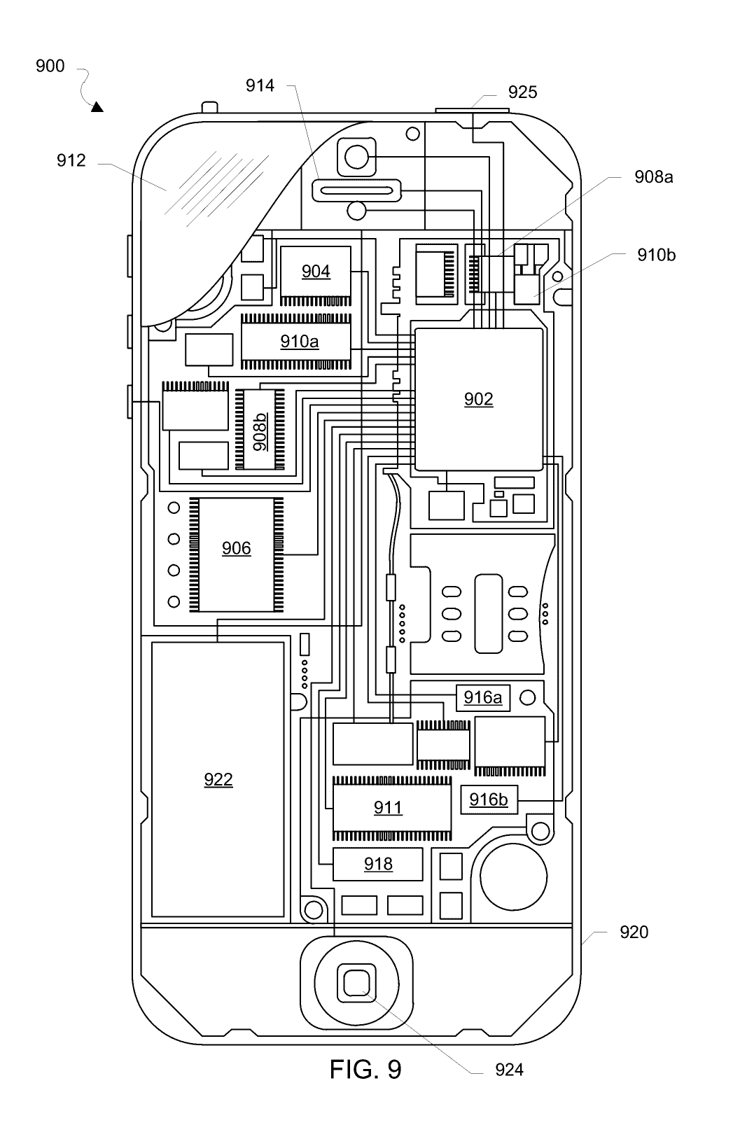

The various embodiments may be implemented in any of a variety of UEs, an example of which is illustrated in FIG. 9, as a UE 900, which may correspond to the UE 110, 200 in FIGS. 1-2. As such, the UE 900 may implement the process and/or the apparatus of FIGS. 1-8, as described herein.

With reference to FIGS. 1-9, the UE 900 may include a processor 902 coupled to a touchscreen controller 904 and an internal memory 906. The processor 902 may be one or more multi-core integrated circuits designated for general or specific processing tasks. The memory 906 may be volatile or non-volatile memory, and may also be secure and/or encrypted memory, or unsecure and/or unencrypted memory, or any combination thereof. The touchscreen controller 904 and the processor 902 may also be coupled to a touchscreen panel 912, such as a resistive-sensing touchscreen, capacitive-sensing touchscreen, infrared sensing touchscreen, etc. Additionally, the display of the UE 900 need not have touch screen capability.

The UE 900 may have one or more cellular network transceivers 908a, 908b coupled to the processor 902 and to two or more antennae 910 and configured for sending and receiving cellular communications. The transceivers 908 and antennae 910a, 910b may be used with the above-mentioned circuitry to implement the various embodiment methods. The cellular network transceivers 908a, 908b may be the RF resources 218a, 218b, respectively. The antennae 910a, 910b may be the wireless antenna 220a, 220b. The UE 900 may include two or more SIM cards 916a, 916b, corresponding to SIM-1 204a and SIM-2 204b, coupled to the transceivers 908a, 908b, and/or the processor 902. The UE 900 may include a cellular network wireless modem chip 911 (e.g., the baseband processor 216) that enables communication via a cellular network and is coupled to the processor.

The UE 900 may include a peripheral device connection interface 918 coupled to the processor 902. The peripheral device connection interface 918 may be singularly configured to accept one type of connection, or multiply configured to accept various types of physical and communication connections, common or proprietary, such as USB, FireWire, Thunderbolt, or PCIe. The peripheral device connection interface 918 may also be coupled to a similarly configured peripheral device connection port (not shown).

The UE 900 may also include speakers 914 for providing audio outputs. The UE 900 may also include a housing 920, constructed of a plastic, metal, or a combination of materials, for containing all or some of the components discussed herein. The UE 900 may include a power source 922 coupled to the processor 902, such as a disposable or rechargeable battery. The rechargeable battery may also be coupled to a peripheral device connection port (not shown) to receive a charging current from a source external to the UE 900. The UE 900 may also include a physical button 924 for receiving user inputs. The UE 900 may also include a power button 926 for turning the UE 900 on and off

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Various modifications to embodiments described herein will be readily apparent to those skilled in the art, and the generic principles defined herein may be applied to some embodiments without departing from the spirit or scope of the disclosure. Thus, the present disclosure is not intended to be limited to the embodiments shown herein but is to be accorded the widest scope consistent with the following claims and the principles and novel features described herein.

1. A method for managing acquisitions, comprising:
executing a first portion of a first acquisition process for acquiring service for a first subscription of a user equipment (UE);
obtaining at least one parameter as a result of executing the first portion of the first acquisition process; and
executing a second portion of a second acquisition process for acquiring service for a second subscription of the UE using the at least one parameter.

2. The method of claim 1, further comprising providing the UE with the first subscription and the second subscription.

3. The method of claim 1, wherein the first subscription and the second subscription are associated with a same radio access technology (RAT).

4. The method of claim 1, wherein the first subscription and the second subscription are associated with a same public land mobile network (PLMN).

5. The method of claim 1, wherein executing the second portion of the second acquisition process comprises:
determining a public land mobile network (PLMN) associated with each of the first subscription and the second subscription; and
executing the second portion of the second acquisition process based on the at least one parameter when the PLMN associated with the first subscription and the PLMN associated with the second subscription are the same.

6. The method of claim 1, wherein the at least one parameter is at least one of frequency, primary scrambling code (PSC), frame timing, or system information.

7. The method of claim 1, wherein:
the second portion of the second acquisition process comprises at least a frequency pull-in stage; and
one of the at least one parameter is used in the frequency pull-in stage.

8. The method of claim 7, wherein:
the frequency pull-in stage comprises at least a multipath searching phase and a pulling-in phase; and
one of the at least one parameter is used in the multipath searching phase.

9. The method of claim 8, wherein the second acquisition process comprises only the second portion.

10. The method of claim 1, wherein:
the first portion of the first acquisition process comprises a frequency scanning stage and a primary scrambling code (PSC) determination stage;
the frequency scanning stage comprises at least a frequency band raw scanning phase and a fine scanning phase based on a center frequency; and
the PSC determination stage comprises at least a slot synchronization phase using a primary synchronization channel (P-SCH), a code group and frame timing phase using a secondary synchronization channel (S-SCH), and a PSC identification phase using common pilot channel (CPICH).

11. The method of claim 10, wherein the first portion of the first acquisition process further comprises a frequency pull-in stage, a PCCPCH transmission time interval (TTI) synchronization stage, system information reading stage, and cell selection stage, wherein the frequency pull-in stage comprises a multipath searching phase and rake receiver to multipath phase.

12. The method of claim 1, further comprising:
storing the at least one parameter in a memory storage; and
retrieving the at least one parameter from the memory storage for executing the second portion of the second acquisition process.

13. The method of claim 12, wherein the at least one parameter is stored in response to the completion of the first acquisition process.

14. The method of claim 12, wherein the at least one parameter is retrieved in response to determining that a first PLMN associated with the first subscription and a second PLMN associated the second subscription are the same.

15. The method of claim 1, wherein the second portion of the second acquisition process comprises a multipath searching phase, a rake receiver to multipath phase, and a cell selection phase.

16. A user equipment (UE) configured for managing acquisitions, the UE comprising:
a processor, the processor configured to:
execute a first portion of a first acquisition process for acquiring service for a first subscription of the UE;
obtain at least one parameter as a result of executing the first portion of the first acquisition process; and
execute a second portion of a second acquisition process for acquiring service for a second subscription of the UE using the at least one parameter.

17. The UE of claim 16, further comprising:
a first subscriber identity module (SIM) associated with the first subscription; and
a second SIM associated with the second subscription.

18. The UE of claim 16, wherein the first subscription and the second subscription are associated with a same radio access technology (RAT).

19. The UE of claim 16, wherein the first subscription and the second subscription are associated with a same public land mobile network (PLMN).

20. The UE of claim 16, wherein executing the second portion of the second acquisition process comprises:
determining a PLMN associated with each of the first subscription and the second subscription; and
executing the second portion of the second acquisition process based on the at least one parameter when the PLMN associated with the first subscription and the PLMN associated with the second subscription are the same.

21. The UE of claim 16, wherein the at least one parameter is at least one of frequency, primary scrambling code (PSC), frame timing, or system information.

22. The UE of claim 16, wherein:
the second portion of the second acquisition process comprises at least a frequency pull-in stage; and
one of the at least one parameter is used in the frequency pull-in stage.

23. The UE of claim 22, wherein:
the frequency pull-in stage comprises at least a multipath searching phase and a pulling-in phase; and
one of the at least one parameter is used in the multipath searching phase.

24. The UE of claim 23, wherein the second acquisition process comprises only the second portion.

25. The UE of claim 16, wherein:
the first portion of the first acquisition process comprises a frequency scanning stage and a PSC determination stage;
the frequency scanning stage comprises at least a frequency band raw scanning phase and a fine scanning phase based on a center frequency; and
the PSC determination stage comprises at least a slot synchronization phase using a primary synchronization channel (P-SCH), a code group and frame timing phase using a secondary synchronization channel (S-SCH), and a PSC identification phase using common pilot channel (CPICH).

26. The UE of claim 16, the UE further comprises a memory storage, wherein the processor is further configured to:
store the at least one parameter in the memory storage; and
retrieve the at least one parameter from the memory storage for executing the second portion of the second acquisition process.

27. The UE of claim 26, wherein the at least one parameter is retrieved in response to determining that a first PLMN associated with the first subscription and a second PLMN associated the second subscription are the same.

28. A non-transitory computer readable-medium containing instructions such that, when executed, causes a processor to:
execute a first portion of a first acquisition process for acquiring service for a first subscription of the UE;
obtain at least one parameter as a result of executing the first portion of the first acquisition process; and
execute a second portion of a second acquisition process for acquiring service for a second subscription of the UE using the at least one parameter.

29. The non-transitory computer readable-medium of claim 28, wherein the processor executes the second portion of the second acquisition process by:
determining a public land mobile network (PLMN) associated with each of the first subscription and the second subscription; and
executing the second portion of the second acquisition process based on the at least one parameter when the PLMN associated with the first subscription and the PLMN associated with the second subscription are the same.

30. A system for managing acquisitions, the system comprising:
means for executing a first portion of a first acquisition process for acquiring service for a first subscription of the UE;
means for obtaining at least one parameter as a result of executing the first portion of the first acquisition process; and
means for executing a second portion of a second acquisition process for acquiring service for a second subscription of the UE using the at least one parameter.
